(19) United States
(12) Patent Application Publication
(10) Pub. No.: US 2014/0080411 A1
(43) Pub. Date: Mar. 20, 2014

(54) INTEGRATION OF A NEAR FIELD COMMUNICATION COIL ANTENNA BEHIND A SCREEN DISPLAY FOR NEAR FIELD COUPLING

(71) Applicants: Anand S. Konanur, Sunnyvale, CA (US); Janardhan Koratikere Narayan, Sunnyvale, CA (US); Ulun Karacaoglu, San Jose, CA (US); Akihiro Takagi, San Mateo, CA (US); Songnan Yang, San Jose, CA (US)

(72) Inventors: Anand S. Konanur, Sunnyvale, CA (US); Janardhan Koratikere Narayan, Sunnyvale, CA (US); Ulun Karacaoglu, San Jose, CA (US); Akihiro Takagi, San Mateo, CA (US); Songnan Yang, San Jose, CA (US)

(21) Appl. No.: 13/721,167

(22) Filed: Dec. 20, 2012

Related U.S. Application Data
(60) Provisional application No. 61/701,022, filed on Sep. 14, 2012.

(51) Int. Cl. H04B 5/00

(52) U.S. Cl. CPC H04B 5/0025
USPC 455/41.1

(57) ABSTRACT

Described herein are architectures, platforms and methods for integrating near field communication (NFC) coil antenna behind a screen display of devices and more particularly, to improve near field coupling capabilities of the devices by configuring the screen display to implement a context based software logo to guide a user. The context based software logo displays a tapping area location during NFC related functions. The NFC related functions include wireless power transfer (WPT) and/or near field communications (NFC) capabilities of the devices

### RELATED APPLICATION

This application claims the benefit of priority of U.S. Provisional Patent Application Ser. No. 61/701,022 filed Sep. 14, 2012.

### BACKGROUND

Near field communication (NFC) is an emerging radio frequency identifier (RFID) based technology that promises to enable wireless transfer of data over very short distances and replace regular contact based interactions with a contactless interaction between two devices or a device and a card placed in close proximity. Typical usages include coupons, identifier (ID) cards, mobile payments and peer to peer connections between devices.

A key challenge in the integration of NFC radios into devices, such as Ultrabooks, tablets, phones, and All-In-One desktops, etc., is finding space in a metallic chassis to accommodate the relatively large coil antenna typically used to provide acceptable user experience with NFC. For example, the smallest coils typically used that are able to provide acceptable user experience are about 30 mm×50 mm. Furthermore, larger coils may be used to support certain certification requirements, such as those imposed by the NFC forum (e.g., proximity usages) and EMVCo (e.g., payment usages).

Coil antennas may be integrated with cutouts to the metal frames of a device chassis, such as on the palm rest of Ultrabooks or notebooks, in the bezel of All-in-Ones, and on the plastic back cover of phones and tablets. Such solutions may severely restrict either the size of coils (e.g., area of a palm rest) and/or impact chassis design (e.g., need to have plastic back covers in handhelds, bezel in all-in-one, etc). In addition, with the advent of convertible devices, many of these tapping surfaces may be completely covered in at least one device configuration (i.e., tablet mode, notebook mode, etc.).

### BRIEF DESCRIPTION OF THE DRAWINGS

The detailed description is described with reference to accompanying figures. In the figures, the left-most digit(s) of a reference number identifies the figure in which the reference number first appears. The same numbers are used throughout the drawings to reference like features and components.

FIG. 1 is a diagram of an example device that implements integration of a near field communication (NFC) coil antenna behind a screen display.

FIG. 2A is a diagram of an example convertible or tablet device that implements integration of a near field communication (NFC) coil antenna behind a screen display.

FIG. 2B is a diagram of an example handheld device that implements integration of a near field communication (NFC) coil antenna behind a screen display.

FIG. 2C is a diagram of an example all in one (AIO) device that implements integration of a near field communication (NFC) coil antenna behind a screen display.

FIG. 3 is a diagram of an example coil antenna integration in a screen display of a device.

FIG. 4 is a diagram of an example coil antenna integration in a screen display of a device.

FIG. 5 is a diagram of an example coil antenna integration in a screen display of a device.

FIG. 6 is a diagram example system for implementing a near field communication (NFC) coil antenna behind a screen display.

FIG. 7 shows an example process chart illustrating an example method for integrating a coil antenna in a screen display of a device.

### DETAILED DESCRIPTION

Described herein are architectures, platforms and methods for integrating near field communication (NFC) coil antenna behind a screen display of devices and more particularly, to improve near field coupling capabilities of the devices by configuring the screen display to implement a context based software logo to guide a user. For example, the context based software logo displays a tapping area location during NFC related functions. The NFC related functions include (by way of illustration and not limitation) wireless power transfer (WPT) and/or near field communications (NFC) capabilities of the devices (e.g., portable devices).

In an implementation, a coil antenna is integrated between the screen display and a chassis (e.g., plastic, metallic, or a carbon fiber chassis) of the device. In this implementation, the NFC related functions may be performed at display side and/or from behind depending upon the chassis type of the device. For example, in a liquid crystal display (LCD) display of the device, the coil antenna may be positioned in a location where no metallic materials are present in between the LCD display and the coil antenna. In this example, if the chassis is plastic and there is no battery between the coil antenna and the plastic chassis, the near field coupling may be implemented from the display side (to cover Me-to-Me-usages) and/or from behind the device (to cover Me-to-You point to point or P2P usages). In another example, a ferrite material may be inserted underneath the coil antenna if the metallic chassis is utilized to hold the screen display in the device.

In another implementation, the coil antenna may be embedded between a front polarizer component and a color filter glass component of the LCD display, or the coil antenna is embedded between the color filter glass component and a thin film transistor (TFT) glass component of the LCD display. In this implementation, the front polarizer, color filter glass, and the TFT glass components are composite materials in current LCD technologies to improve its performance. Furthermore, the integration of the coil antenna within these composite materials neither affects normal operation of the LCD screen display nor it affects near field coupling performance of the device.

As an example of present implementation herein, the context based software logo is configured to display at the screen display a guide for the tapping area location. For example, if the coil antenna is positioned at a top left portion of the screen display due to absence of electromagnetic interference (EMI) or Eddy current in that particular area, then the context based software logo may display at the top left portion a shadow or a picture of the coil antenna to show its exact location. Furthermore, the context based software logo may be configured to display the current type of transaction (e.g., NFC, WPT, etc.), indication of a successful read, indication of maximum power transfer during WPT, and the like.

In other implementations, the coil antenna integration in the screen display as discussed above may be implemented in an advertisement billboards, vehicle dashboard screen display, and the like.

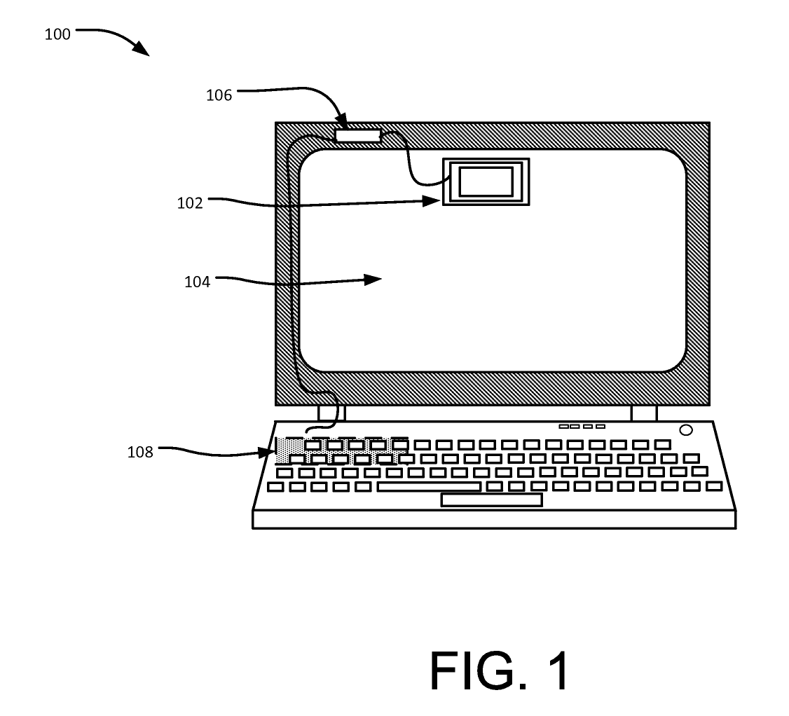

FIG. 1 is an example device 100 that implements NFC related functions. The example device 100 may contain a coil antenna 102, a screen display 104, an NFC module 106, and a motherboard 108.

As an example of present implementation herein, the example device 100 may include, but are not limited to, Ultrabooks, a tablet computer, a netbook, a notebook computer, a laptop computer, mobile phone, a cellular phone, a smartphone, a personal digital assistant, a multimedia playback device, a digital music player, a digital video player, a navigational device, a digital camera, and the like. In this example, the example device 100 may contain the coil antenna 102 that is utilized for near field coupling functions.

As an example of present implementation herein, the coil antenna 102 is a continuous loop of coil antenna that may be made out of a printed circuit board (PCB), a flexible printed circuit (FPC), a metal wire, created through a laser direct structuring (LDS) process, or directly embedded to the screen display 104. In this example, the coil antenna 102 may be configured to operate on a resonant frequency (e.g., 13.56 MHz to implement NFC and/or WPT operations), and independent from another transceiver antenna that uses another frequency for wireless communications (e.g., 5 GHz for Wi-Fi signals).

As an example of present implementation herein, the coil antenna 102 may be positioned in between the screen display 104 and a chassis (not shown) that holds the screen display 104. In this example, a location of the coil antenna 102 may be anywhere within an area that is covered by the screen display 104. This configuration is implemented in order for context-based software logo (not shown) to clearly display or illustrates the exact tapping area during near field coupling functions. For example, if the coil antenna 102 is positioned at middle-top portion/location of the screen display 104, then the context-based software logo may be able to display an imaginary picture to show the exact tapping location for the coil antenna 102. In this example, the coil antenna 102 may be inserted in between the screen display 104 and the chassis, or the coil antenna 102 may be directly integrated to composite materials or components (not shown) that make up the screen display 104.

When the coil antenna 102 is inserted in between the screen display 104 and a metallic or a carbon fiber chassis, a ferrite material may be provided in between the coil antenna 102 and the metallic or carbon fiber chassis to isolate the coil antenna 102 from any detrimental effects of Eddy currents that may be induced on the metallic or carbon fiber chassis. However, in case of a plastic chassis, the display 104 and the plastic chassis may not hinder NFC communications that may be implemented at front side of the screen display 104, or at backside through the chassis.

As an example of present implementation herein, the screen display 104 may be implemented using standard LCD panels or other types of screen displays, including screen displays with touch panels. Example screen display 104 may include in-plane switching (IPS), twist nematic (TN), fringe field switching (FFS), vertical alignment (VA) and optically compensated bend-mode (OCB) screen displays. In other implementations, the screen display 104 is fused to the chassis of the device 100. In this implementation, the screen display 104, the coil antenna 102 and the chassis are integrated or fused in a single package.

Furthermore, the screen display 104 may be chosen based on their NFC magnetic field pass through performance. In general, the screen display 104 will provide for sufficient pass through of a magnetic field for the NFC experience/communication. It is understood that some interference may exist with particular displays; however, such interference should not affect the NFC experience.

As an example of present implementation herein, the NFC module 106 is coupled to the motherboard 108 in order to provide tuning to the coil antenna 102. In other words, the NFC module 106 may be configured to act as a control circuit to the coil antenna 102. For example, the coil antenna 102 may be utilized for NFC communications, WPT, Europay MasterCard and Visa (EMV) transactions, or Microsoft Proximity communications. In this example, the NFC module 108 is configured to provide control to the coil antenna 102.

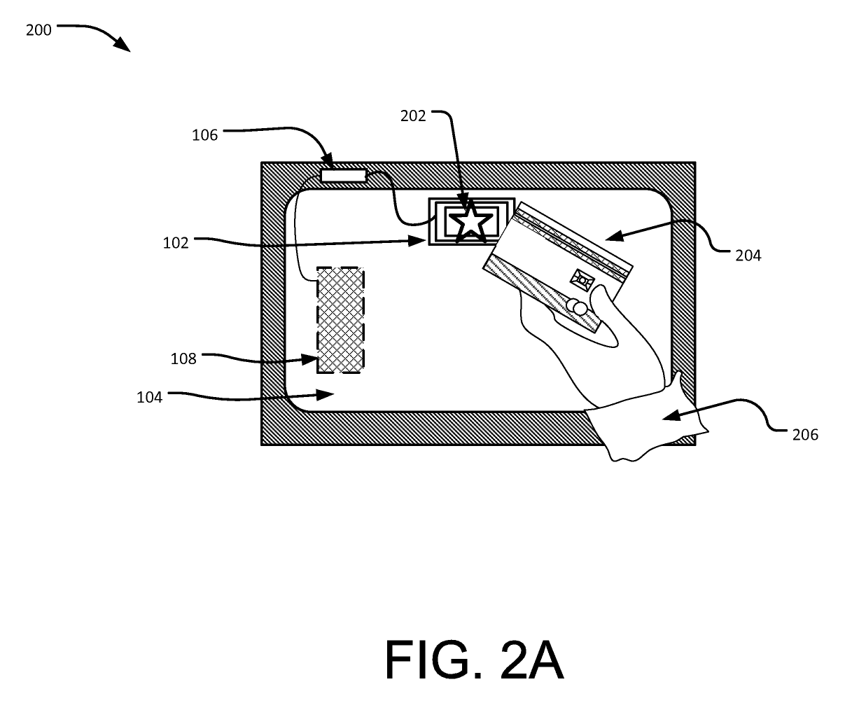

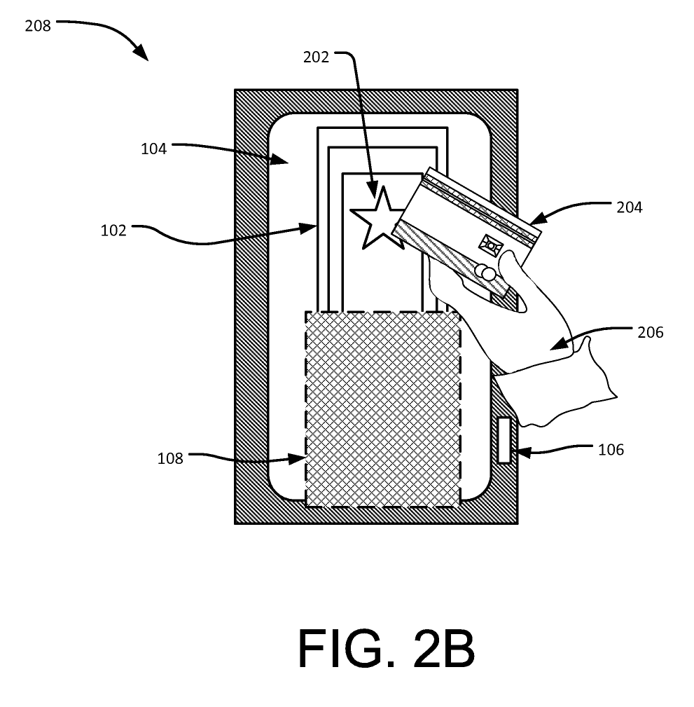

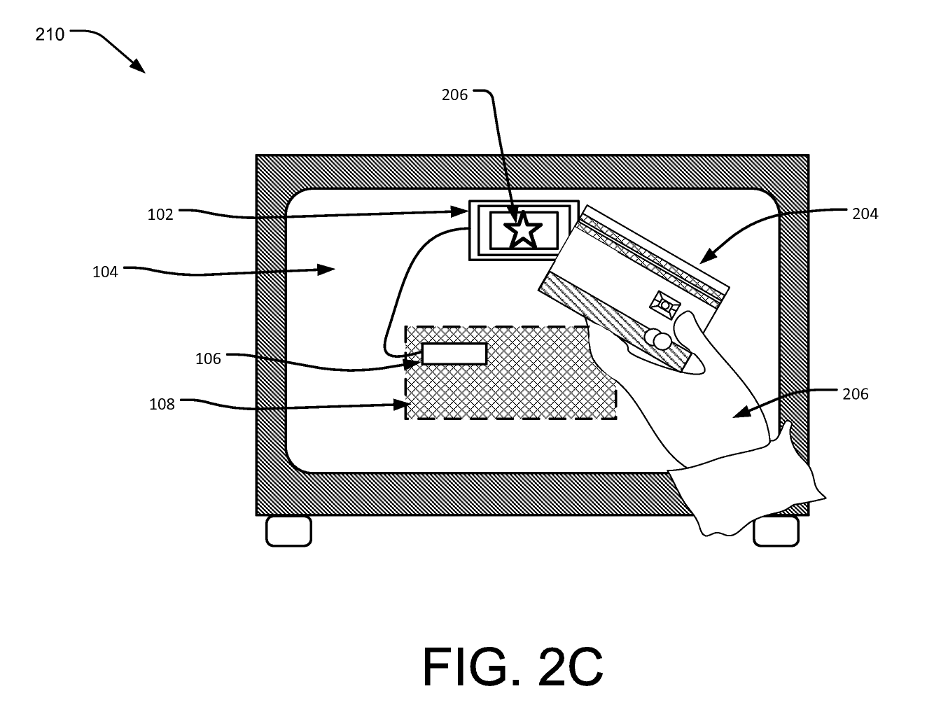

FIGS. 2A, 2B, and 2C are example implementations of the coil antenna integration into the screen display of different types of devices.

For example, FIG. 2A shows a convertible tablet 200 with a context based software logo 202 and a credit card 204 that is tapped by a user 206 to the screen display 104. In an implementation, the context based software logo 202 may display an image (e.g., star logo) to guide the user 206 into exact tapping location (i.e., optimum location) for the coil antenna 102. In this implementation, the context based software logo 202 may be configured to display the image that corresponds to current transaction. For example, the star logo may indicate NFC communications. In another example, another image (not shown) at the same exact location may indicate EMV transaction or Microsoft® Proximity communications.

As an example of present implementation herein, the context based software logo 202 may indicate the current program that is running in the system that utilizes the coil antenna 102. For example, during WPT operations, the context based software logo 202 may display if maximum power is transferred by computing coupling coefficients between mutual inductive coils. In another example, during NFC communications, the context based software logo 202 may display if NFC communication transaction is completed or positioning of the credit card 204 is not within a threshold for near field coupling. In this example, the threshold may contain a minimum amount of coupling between the coil antenna 102 and the credit card 204 to engage in NFC related functions.

FIG. 2B is an example handheld device 208 with the coil antenna 102 that is integrated underneath the screen display 104. In an implementation, the integration of the coil antenna 102 overlaps the motherboard 108. In this implementation, a ferrite material (not shown) is inserted in between the coil antenna 102 and the motherboard 108 in order to isolate detrimental effects of Eddy currents that may be induced in metallic components of the motherboard 108. For example, the Eddy currents may provide EMI to the coil antenna 102 during the NFC related functions. In this example, the inserted ferrite material may include a highly permeable material that is mounted underneath the coil antenna 102 that overlaps with the motherboard 108.

FIG. 2C is an example All-In-One (AIO) device 210 that implements NFC related functions through the coil antenna 102 that is integrated underneath the screen display 104. In an implementation, the coil antenna 102 may be integrated within composite materials (not shown) that make up the screen display 104 or the coil antenna 102 may be positioned to an area of the screen display 104 with least EMI that may affect NFC related functions operations. Similar to FIGS. 2A and 2B above, the AIO device 210 may include the context based software logo 206 in order to guide the user 206 to the exact tapping location during implementation of NFC related functions. Furthermore, the context based software logo 206 may display the type of current transaction or the status of the current transaction. For example, the status may indicate if the NFC communication is completed or partially completed.

In other implementations, the configurations or principles applied in FIGS. 2A, 2B and 2C may be implemented in vehicle displays such as, in a vehicle dashboard. Furthermore, these configurations may be similarly applied, but not limited to, NFC enabled advertising billboards. NFC enabled advertising billboards may be public displays that for example allow the user 206 to tap the device 200 to the billboard to received information, such as a uniform resource locator (URL) to an advertiser's website/ad.

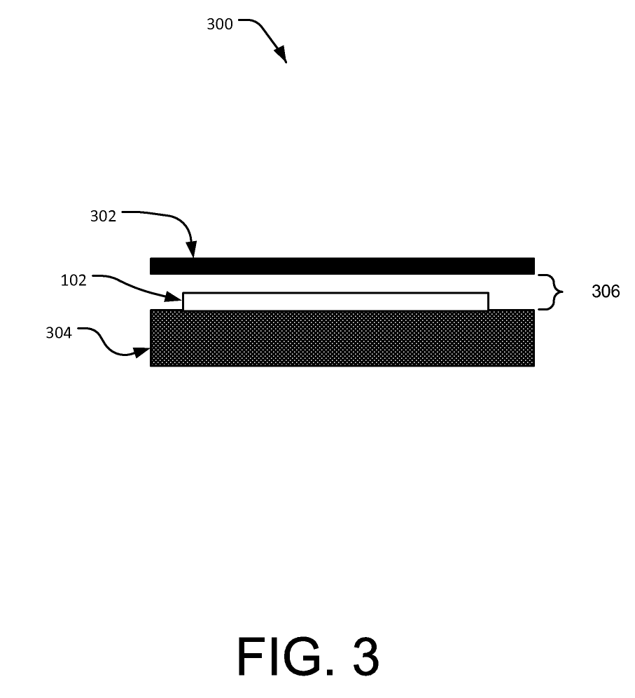

FIG. 3 is an example coil antenna integration 300 in which the coil antenna 102 is integrated with components of the screen display 104. In an implementation, the coil antenna 102 may be natively embedded within an assembly of the screen display 104 to allow seamless enabling of NFC reader device with NFC receiver device. In this implementation, a reduction of z-height is created with a minimal impact as compared to existing methodologies.

As an example of present implementation herein, the screen display 104 such as, a thin film transistor liquid crystal display (TFT LCD) contains a sandwich-like structure that includes a front polarizer 302 and a color filter glass 304 that is separated by a space or gap 306. In this example, the coil antenna 102 may be embedded between the front polarizer 302 and the color filter glass 304 without affecting the operations of the TFT LCD and without detrimental effects to the NFC related functions operations.

In an implementation, the front polarizer 302 is a component of the screen display 104 that changes direction of light that is provided by the color filter glass 304. In this implementation, the color filter glass 304 generates the light (i.e., as color representations) according to amount of the light that is supplied by a back light component (not shown). The supplied light may be utilized to project an image to be displayed at the screen display 104.

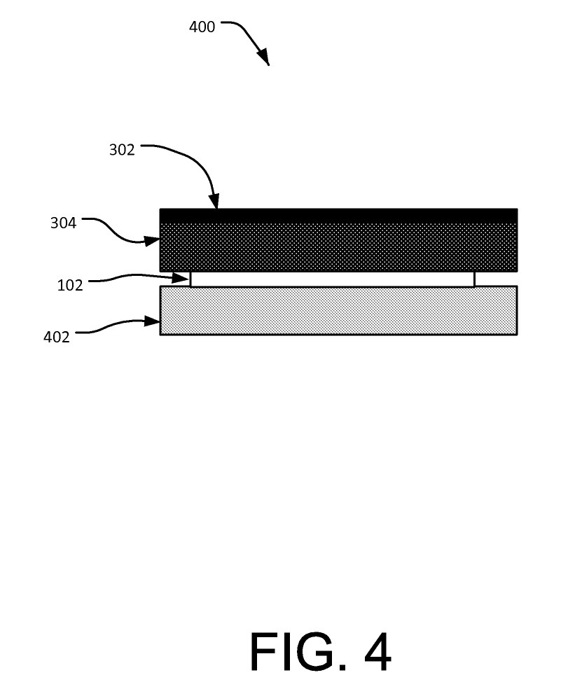

FIG. 4 is an example coil antenna integration 400 in which the coil antenna 102 is integrated with the components of the screen display 104. In an implementation, the coil antenna 102 is positioned in between the color filter glass 304 and a TFT glass polarizer 402. For example, the TFT glass polarizer 402 is a glass substrate on which a special optical coating is applied. This glass substrate may either be a plate that is inserted into a beam at a particular angle. In an implementation, the integration of the coil antenna 102 within these composite materials that make up the screen display 104 does not affect its regular operation to project desired images such as, multimedia, information, and the like. Furthermore, this configuration may provide a relatively thin structure for the screen display 104. For example, this configuration has no metal shielding path between NFC reader and NFC receiver and as such, it will eliminate any interference in path of NFC sensing.

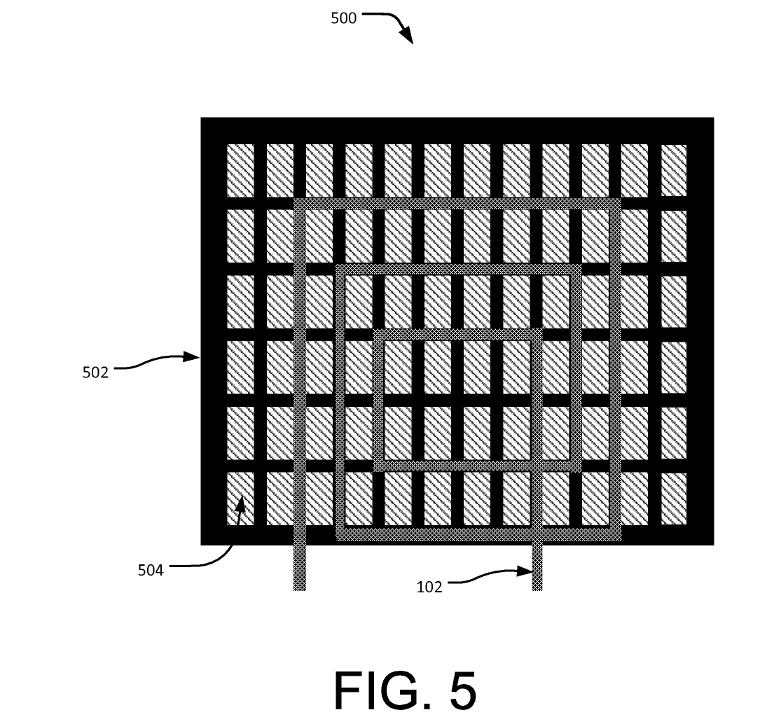

FIG. 5 is an example coil antenna integration 500 in which the coil antenna 102 is integrated with the components of the screen display 104. In an implementation, the coil antenna 102 is configured to lie on a substrate that contains an invisible black matrix area 502 of the screen display 104. In this implementation, another substrate that contains color filters 504 are configured to lie on the invisible black matrix area 502; however, the color filters 504 do not overlap with the coil antenna 102 that is positioned within the invisible black matric area 502. In other words, the coil antenna 102 is configured to be integrated in the screen display 104 without affecting operations of the substrate that contains the color filters 504.

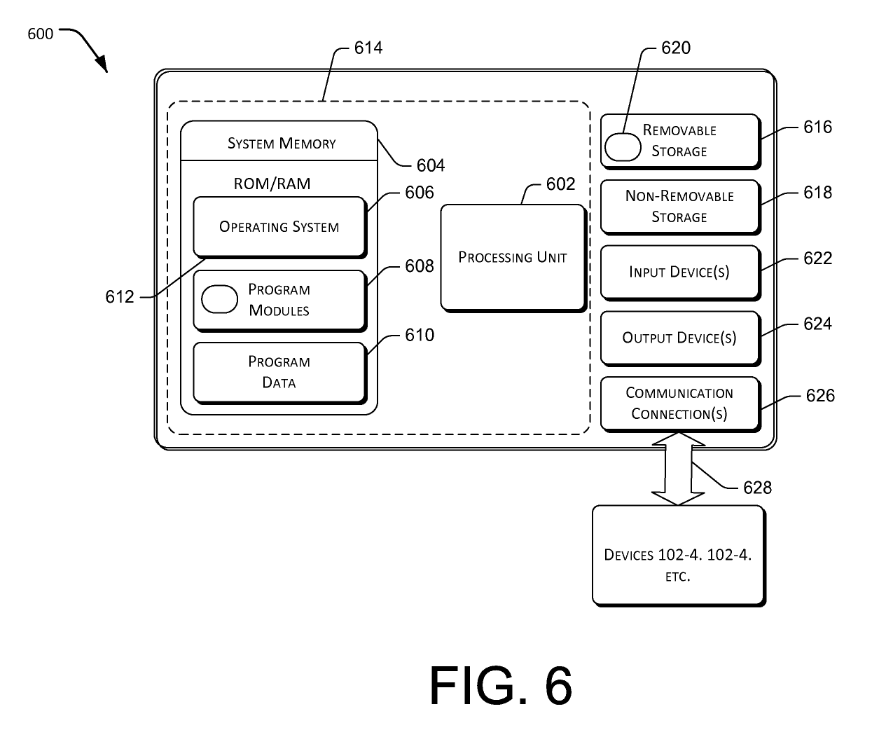

FIG. 6 is an example system that may be utilized to implement various described embodiments. However, it will be readily appreciated that the techniques disclosed herein may be implemented in other computing devices, systems, and environments. The computing device 600 shown in FIG. 6 is one example of a computing device and is not intended to suggest any limitation as to the scope of use or functionality of the computer and network architectures.

In at least one implementation, computing device 600 typically includes at least one processing unit 602 and system memory 604. Depending on the exact configuration and type of computing device, system memory 604 may be volatile (such as RAM), non-volatile (such as ROM, flash memory, etc.) or some combination thereof. System memory 604 may include an operating system 606, one or more program modules 608 that implement the long delay echo algorithm, and may include program data 610. A basic implementation of the computing device 600 is demarcated by a dashed line 614.

The program module 608 may include a module 612 configured to implement the one-tap connection and synchronization scheme as described above. For example, the module 612 may carry out one or more of the method 600, and variations thereof, e.g., the computing device 600 acting as described above with respect to the device 102.

Computing device 600 may have additional features or functionality. For example, computing device 600 may also include additional data storage devices such as removable storage 616 and non-removable storage 618. In certain implementations, the removable storage 616 and non-removable storage 618 are an example of computer accessible media for storing instructions that are executable by the processing unit 602 to perform the various functions described above. Generally, any of the functions described with reference to the figures may be implemented using software, hardware (e.g., fixed logic circuitry) or a combination of these implementations. Program code may be stored in one or more computer accessible media or other computer-readable storage devices. Thus, the processes and components described herein may be implemented by a computer program product. As mentioned above, computer accessible media includes volatile and non-volatile, removable and non-removable media implemented in any method or technology for storage of information, such as computer readable instructions, data structures, program modules, or other data. The terms “computer accessible medium” and “computer accessible media” refer to non-transitory storage devices and include, but are not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium that may be used to store information for access by a computing device, e.g., computing device 600 and wireless mobile device 102. Any of such computer accessible media may be part of the computing device 600.

In one implementation, the removable storage 616, which is a computer accessible medium, has a set of instructions 630 stored thereon. When executed by the processing unit 602, the set of instructions 630 cause the processing unit 602 to execute operations, tasks, functions and/or methods as described above, including method 600 and any variations thereof.

Computing device 600 may also include one or more input devices 620 such as keyboard, mouse, pen, voice input device, touch input device, etc. Computing device 600 may additionally include one or more output devices 622 such as a display, speakers, printer, etc.

Computing device 600 may also include one or more communication connections 624 that allow the computing device 600 to communicate wirelessly with one or more other wireless devices, over wireless connection 628 based on near field communication (NFC), Wi-Fi, Bluetooth, radio frequency (RF), infrared, or a combination thereof.

It is appreciated that the illustrated computing device 600 is one example of a suitable device and is not intended to suggest any limitation as to the scope of use or functionality of the various embodiments described.

Unless the context indicates otherwise, the term “Universal Resource Identifier” as used herein includes any identifier, including a GUID, serial number, or the like.

In the above description of example implementations, for purposes of explanation, specific numbers, materials configurations, and other details are set forth in order to better explain the present invention, as claimed. However, it will be apparent to one skilled in the art that the claimed invention may be practiced using different details than the example ones described herein. In other instances, well-known features are omitted or simplified to clarify the description of the example implementations.

The inventors intend the described example implementations to be primarily examples. The inventors do not intend these example implementations to limit the scope of the appended claims. Rather, the inventors have contemplated that the claimed invention might also be embodied and implemented in other ways, in conjunction with other present or future technologies.

Moreover, the word “example” is used herein to mean serving as an example, instance, or illustration. Any aspect or design described herein as “example” is not necessarily to be construed as preferred or advantageous over other aspects or designs. Rather, use of the word example is intended to present concepts and techniques in a concrete fashion. The term “techniques”, for instance, may refer to one or more devices, apparatuses, systems, methods, articles of manufacture, and/or computer-readable instructions as indicated by the context described herein.

As used in this application, the term “or” is intended to mean an inclusive “or” rather than an exclusive “or.” That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more”, unless specified otherwise or clear from context to be directed to a singular form.

These processes are illustrated as a collection of blocks in a logical flow graph, which represents a sequence of operations that may be implemented in mechanics alone or a combination with hardware, software, and/or firmware. In the context of software/firmware, the blocks represent instructions stored on one or more computer-readable storage media that, when executed by one or more processors, perform the recited operations.

Note that the order in which the processes are described is not intended to be construed as a limitation, and any number of the described process blocks may be combined in any order to implement the processes or an alternate process. Additionally, individual blocks may be deleted from the processes without departing from the spirit and scope of the subject matter described herein.

The term “computer-readable media” includes computer-storage media. In one embodiment, computer-readable media is non-transitory. For example, computer-storage media may include, but are not limited to, magnetic storage devices (e.g., hard disk, floppy disk, and magnetic strips), optical disks (e.g., compact disk (CD) and digital versatile disk (DVD)), smart cards, flash memory devices (e.g., thumb drive, stick, key drive, and SD cards), and volatile and non-volatile memory (e.g., random access memory (RAM), read-only memory (ROM)).

Unless the context indicates otherwise, the term “logic” used herein includes hardware, software, firmware, circuitry, logic circuitry, integrated circuitry, other electronic components and/or a combination thereof that is suitable to perform the functions described for that logic.

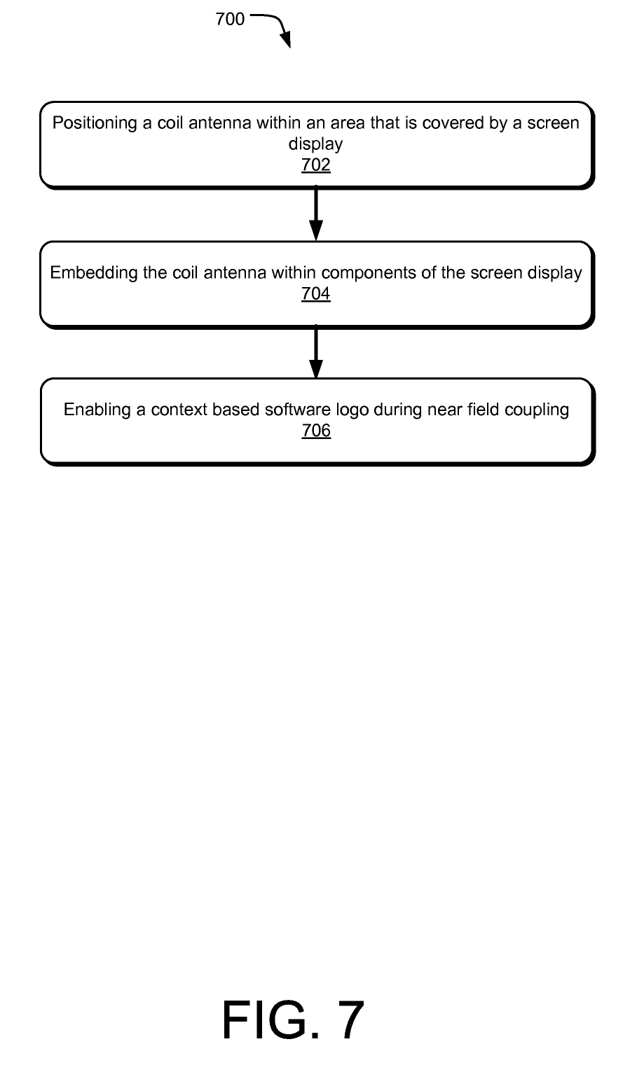

FIG. 7 shows an example process chart 700 illustrating an example method for integrating an NFC antenna within a screen display of a device. The order in which the method is described is not intended to be construed as a limitation, and any number of the described method blocks can be combined in any order to implement the method, or alternate method. Additionally, individual blocks may be deleted from the method without departing from the spirit and scope of the subject matter described herein. Furthermore, the method may be implemented in any suitable hardware, software, firmware, or a combination thereof, without departing from the scope of the invention.

At block 702, positioning a coil antenna within an area that is covered by a screen display is performed. In an implementation, the coil antenna (e.g., coil antenna 102) is configured to occupy a portion of the area that is defined by the screen display (e.g., screen display 104) of a device (e.g., device 102). In this implementation, a ferrite material is inserted underneath the coil antenna 102 if a metallic material is present (e.g., motherboard 108, battery, metallic chassis, etc.) at the other side of the screen display 104.

At block 704, embedding the coil antenna within components of the screen display is performed. For example, the coil antenna 102 is embedded between a front polarizer component (e.g., front polarizer 302) and a color filter glass component (e.g., color filter glass 304) of the screen display 104, or the coil antenna 102 is embedded between the color filter glass 304 and a thin film transistor (TFT) glass component (e.g., TFT glass component 402) of the screen display 104.

In other implementations, the coil antenna 102 is configured to lie in a substrate (e.g., invisible black matrix area 502) that does not overlap with another substrate that contains color filters (e.g., color filters 504). In this implementation, a relatively thin screen display 104 may be generated.

At block 706, enabling a context based software logo during near field coupling is performed. For example, the context based software logo (e.g., context based software logo 202) is configured to display current type of transaction, status of the current transaction, the exact tapping location during the near field coupling, and the like.

Realizations in accordance with the present invention have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the various configurations may be implemented as a combined structure or component. These and other variations, modifications, additions, and improvements may fall within the scope of the invention as defined in the claims that follow.

What is claimed is:

1. A device comprising:
one or more processors;
a memory configured to the one or more processors;
a near field communications (NFC) antenna configured to the one or more processors, the NFC antenna integrated in a screen display of the device, the screen display configured to display a software based image that indicates a tapping area for a NFC transaction.

2. The device as recited in claim 1, wherein the NFC antenna is embedded between a front polarizer component and a color filter glass of the screen display.

3. The device as recited in claim 1, wherein the NFC antenna is embedded between the color filter glass component and a thin film transistor (TFT) glass of the screen display.

4. The device as recited in claim 1, wherein the NFC antenna, a ferrite, and the screen display are integrated into a single package.

5. The device as recited in claim 1, wherein the NFC antenna is positioned within an area defined by the screen display.

6. The device as recited in claim 1, wherein the NFC antenna is in a substrate that includes an invisible black matrix area of the screen display.

7. The device as recited in claim 1, wherein the screen display is one of a billboard or a car dashboard screen display.

8. The device as recited in claim 1, wherein the screen display includes in-plane switching (IPS), twisted nematic (TN), fringe field switching (FFS), vertical alignment (VA), or optically compensated bend-mode (OCB) display.

9. The device as recited in claim 1, wherein the NFC transaction is NFC communications, wireless power transfer (WPT), Europay MasterCard and Visa (EMV) transactions, or Microsoft® Proximity Communications.

10. The device as recited in claim 1, wherein the device is one of an Ultrabook, a tablet computer, a netbook, a notebook computer, a laptop computer, a mobile phone, a cellular phone, a smartphone, a personal digital assistant, a multimedia playback device, a digital music player, a digital video player, a navigational device, or a digital camera.

11. A near field communications (NFC) antenna comprising:
a coil antenna integrated within a screen display of a device, the screen display configured to display a software based image that indicates a tapping area for a NFC transaction; and
an NFC module to provide tuning to the coil antenna.

12. The NFC antenna as recited in claim 11, wherein the coil antenna is embedded between a front polarizer component and a color filter glass component of the screen display.

13. The NFC antenna as recited in claim 11, wherein the coil antenna is embedded between a color filter glass component and a thin film transistor (TFT) glass component of the screen display.

14. The NFC antenna as recited in claim 11, wherein the NFC antenna, a ferrite material, and the screen display are integrated or fused into a single package.

15. The NFC antenna as recited in claim 11, wherein the NFC antenna is in a substrate that includes a black matrix area of the screen display.

16. The NFC antenna as recited in claim 11, wherein the screen display includes in-plane switching (IPS), twisted nematic (TN), fringe field switching (FFS), vertical alignment (VA), or optically compensated bend-mode (OCB) display.

17. The NFC antenna as recited in claim 11, wherein the NFC antenna is made out of a printed circuit board (PCB), a flexible printed circuit (FPC), a metal wire, created through a laser direct structuring (LDS) process, or directly embedded to the screen display.

18. A method of integrating a near field communications (NFC) antenna to a screen display of a device, the method comprising:
positioning the NFC antenna in an area that is covered by the screen display;
embedding the NFC antenna within components of the screen display; and
enabling a context based software logo during near field coupling, the context based software logo is configured to display a logo image that includes a tapping area location during the near field coupling.

19. The method as recited in claim 18, wherein the positioning of the NFC antenna includes the area in the screen display where the logo image is visible to a user.

20. The method as recited in claim 18, wherein the context based software logo is configured to display a current transaction that includes NFC communications, wireless power transfer (WPT), Europay MasterCard and Visa (EMV) transactions, or Microsoft® Proximity Communications.
